(19) United States
(12) Patent Application Publication
(10) Pub. No.: US 2004/0004916 A1
(43) Pub. Date: Jan. 8, 2004

(54) Laser disc signal monitoring and control

(75) Inventor: Nedi Nadershahi, Pleasanton, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Oak Technology, Inc., Sunnyvale, CA

(21) Appl. No.: 10/189,925

(22) Filed: Jul. 3, 2002

(51) Int. Cl. G11B 7/125

(52) U.S. Cl. 369/47.5; 369/53.27; 369/59.11

(57) ABSTRACT

An algorithm for controlling laser power in recording datum including a first recorded pulse and at least one second pulse uses measurements of the recorded datum including peak pulse value, plateau value and a bias value. Average value of the measurements are used with the programmed laser power peak value and a datum envelope value in the algorithm to determine if laser power is to be adjusted, and the sign of calculated values is used to determine positive or negative adjustments. Acquisition circuitry uses a write clock signal which must be delayed in accessing the written datum (WRF).

### BACKGROUND OF THE INVENTION

This invention relates generally to laser disc-drive storage systems, and more particularly the invention relates to the monitoring and control of laser power in recording signals.

U.S. Pat. No. 6,041,028 of Quan and Grimsley, assigned to the present Assignee, is concerned with the dynamic adjustment of pickup signals from laser recorded data in disc drives. As therein described, an optical system such as a CD-ROM stores data in a single, spiral track that circumnavigates the disc thousands of times as it gradually moves away from the center of the disc. In conventional CD-ROM drive systems, CD-ROMs are “read” with a laser beam emitted from an optical pickup suspended beneath the disc. The disc reflects the emitted beam back towards the pickup which contains photodiodes to detect the intensity of the reflected beam. The reflected beam conveys both data and tracking information.

FIG. 1 illustrates an exemplary layout of photodiodes within an optical pickup 10. As shown in this figure, four photodiodes 12-18 (which generates signals A, B, C, and D, respectively) are clustered together at the center and two photodiodes 20, 22 (which generates signals E and F, respectively) are staggered diagonally on the periphery.

FIG. 2 schematically illustrates the writing of data on a disc 24 which rotates on a spindle driven motor 26. Laser source in write optics pickup unit 28 writes the data on disc 24 under control of a write strategy control 30 that controls pulses and phase delays and under control of ROPC 32 (running optimum power control), which actively monitors data formation and continually adjusts the recording power to the optimum power that is required. The volume of laser power applied to the media during write operations depends on many factors such as speed of write, media type, characteristics of the laser driver, electronics and the power control logic, and the recording data. Optimized power can be determined for any combination of these factors in the ROPC module. Each recorded RF data pulse is written by a first laser pulse, a middle laser pulse and optionally a last laser pulse or pulses. As above described, data is read by illuminating the disc with a read laser which is sensed by photodiodes 34.

The present invention is concerned with optimizing the dynamic ROPC-controlled write power.

### BRIEF SUMMARY OF THE INVENTION

In accordance with the invention, an ROPC function is implemented dynamically by sampling data recorded on a disc by a laser to obtain characteristics of the recorded pulses. More particularly, a first time delay occurs from the write (RF) signal, WRF, to the first peak of a written datum, and a second time delay occurs from the first peak to the plateau of the first pulse. The measured data values include an instantaneous peak (i-peak), an instantaneous plateau (i-plateau), and a bias level (i-bias). Averages of the measured values over the sample period are also obtained. A programmed calibrated peak value for the data is known. A ROPC algorithm then uses the measured values to make adjustments in the recording power.

The invention and objects and features thereof will be more readily apparent from the following detailed description and appended claims when taken with the drawings.

### BRIEF DESCRIPTION OF THE DRAWINGS

FIG. 1 is a layout of photodiodes and a conventional optical pickup.

FIG. 2 illustrates laser writing and reading of an RF signal on a disc.

FIG. 3 illustrates a write RF (WRF) signal as recorded on a medium and values thereof which are used in a control algorithm in accordance with the invention.

FIG. 4 is a functional block diagram of the signal sampling circuitry for obtaining the signal values used in the ROPC controlled algorithm.

FIG. 5 illustrates windows for detecting peak power and plateau power as used in FIG. 4.

FIG. 6 is a timing diagram for sampling written data.

### DETAILED DESCRIPTION OF ILLUSTRATIVE EMBODIMENTS

The invention provides a dynamic or running optimum power control to compensate for signal variations resulting from dust, fingerprints, and other debris on the media. The recorded signal is dynamically read and characteristics thereof are used in a ROPC algorithm for dynamically altering recording power as needed.

The recorded data is formed by a pulsed laser beam with the pulses forming a first recorded pulse and one or more second recorded pulses for each datum.

FIG. 3 illustrates a recorded datum (WRF) as read, which is characterized by an instantaneous peak value (i-peak), a calibrated peak value (c-peak), a plateau value following the peak (i-plateau), and a bias or offset value (i-bias). These instantaneous values are used with average values during the sample period in the control algorithm. Several constants (K1, K2, K3) are defined as follows:

K1=(c-peak)−(i-peak-avg)

K2=(c-envelope)−(i-plateau-avg)

K3=(c-envelope)−(i-bias-avg)

Additionally, the constants C1, C2, C3 are preprogrammed so that:

C1+C2+C3=1

These values are used in the following control algorithm:

K1(c1)+K2(c2)+K3(c3)=m (abs value of K1,2,3 are used)

c1+c2+c3=1 (is programmed by MPU.

If the value m from the above algorithm is greater than or equal to a fraction of the c-envelope (selectable from four possible entries), then ROPC action is taken. The sign of the K1 value is used to determine if the power adjustments are in the positive direction or in the negative direction. If K1 is found to be zero, then the value of K2 is used to determine if power adjustments are positive or negative. Similarly, a K3 value is used if the K2 value is also found to be zero.

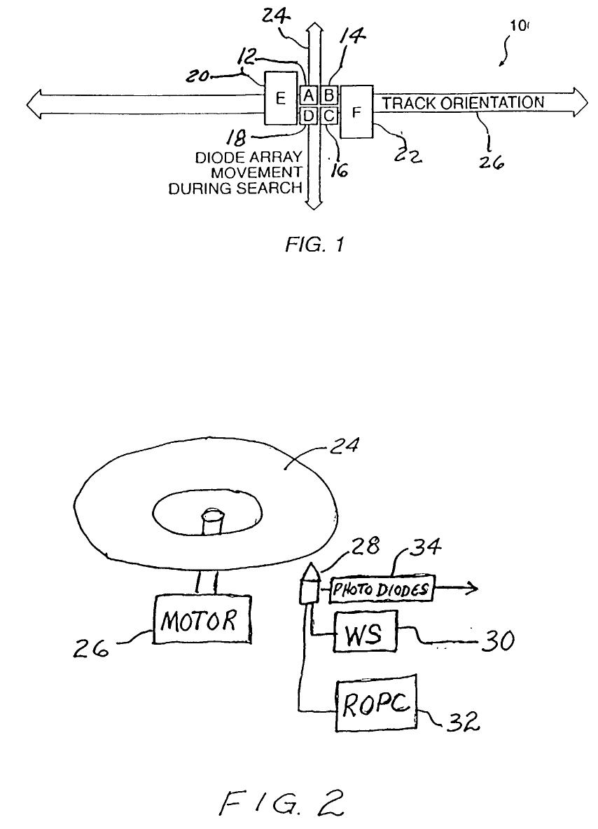

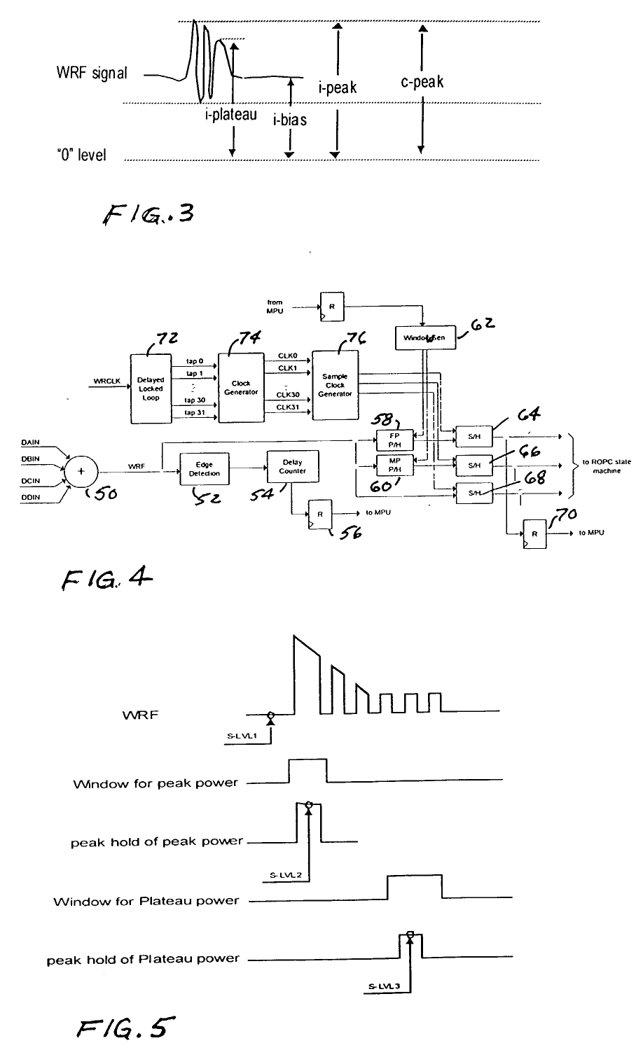

Consider now the circuitry shown in FIG. 4 for timing the acquisitions of the measured values in FIG. 3. In FIG. 4, signals A, B, C, D from FIG. 1 are summed at 50 to provide the WRF signal which is applied through edge detector 52, counter 54, and register flip-flop 56 as feedback to the system computer (MPU). WRF is applied also to a first pulse peak hold detector 58 and a middle pulse peak hold detector 60 which detect the peaks in the WRF signal. The computer provides window signals to detectors 58, 60 through window generator 62.

Sample and hold (S/H) units 64, 66, 68 are connected respectively to detector 58, detector 60, and to WRF to provide the peak signals for the ROPC algorithm. Sample and hold unit 64 provides feedback to the system computer through register 70.

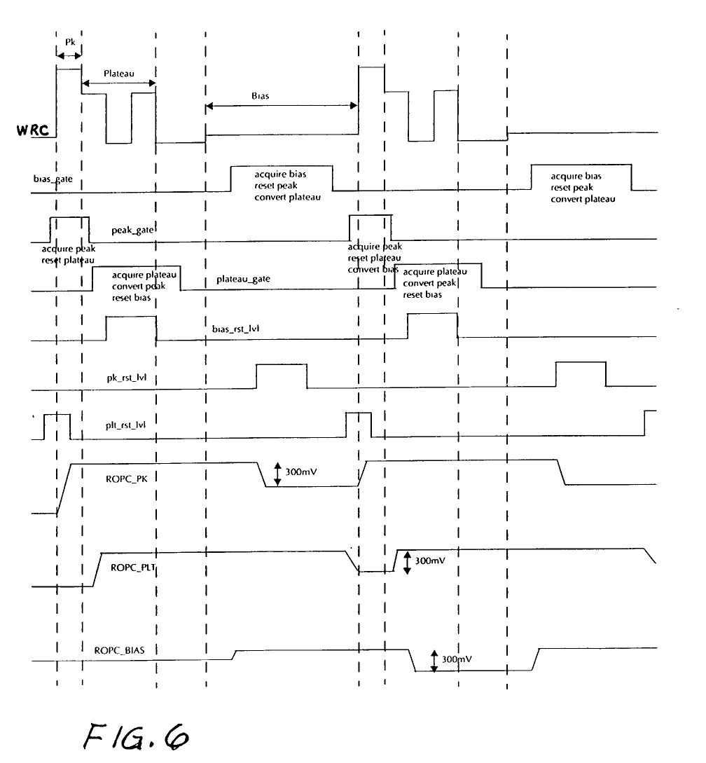

FIG. 5 illustrates the timing windows applied to peak hold detectors 58, 60 from window generator 62. The window for peak power applied to unit 58 occurs during the first pulse of WRF with the peak hold of peak power occurring within this window. Similarly, the window for plateau power occurs after the initial pulses settle down to the plateau as illustrated in FIGS. 3 and 5. Again, the peak hold of the plateau power occurs within the window for plateau power.

The timing for sample and hold units 64, 66, 68 is provided from the write clock (WRCLK) signal in FIG. 4 which is applied through delayed lock loop 72 which compensates for the delay between the leading edge of WRCLK and the initial pulse from the recorded WRF signal. In this embodiment delayed lock loop 72 provides a delay in increments of 1/32 of the write clock in output tap 0 through output tap 31. The delay output initiates clock generator 74 which has a clock frequency thirty-two times WRCLK. Clock generator 74 drives sample clock generator 76 which initiates the S/H units 64, 66 in sampling the P/H units 58, 60 and the sampling of WRF by unit 68.

FIG. 6 is a timing diagram illustrating two WRF data (peak, plateau, and bias) and illustrating the control pulses for acquire peak, acquire plateau, and acquire bias. This is followed by the reset pulses for bias, peak, and plateau. Finally, the sample and hold voltages for peak, plateau, and bias are illustrated (300 mv). Each sampler acquires a sample when its respective gate signal (gate-pk, gate-plt, gate-bias) is high. A sample is cleared (reset) when the respective reset signal (reset-pk, reset-plt, reset-bias) is taken high. Reset has priority over gate.

The algorithm for dynamically controlling the power of the laser write beam in accordance with the invention has proved to be effective in compensating for the recording character of the storage media. While the invention has been described with reference to a specific embodiment, the description is illustrative of the invention and is not to be construed as limiting the invention. Various modifications and applications may occur to those skilled in the art without departing from the true spirit and scope of the invention as defined by the appended claims.

What is claimed is:

1. In a laser recording system in which datum is recorded as a series of pulses including a first pulse and at least a second pulse, a method of monitoring recorded datum and controlling laser power comprising the steps of:
a) measuring a peak value (i-peak) of the datum,
b) measuring a plateau value (i-plateau) of the datum,
c) measuring a bias value (i-bias) of the datum from a “0” level,
d) obtaining average values of i-peak, i-plateau, and i-bias during a sample period, and
e) using the average values along with a programmed power peak value (c-peak) and a datum envelope value (c-envelope) to adjust the programmed power peak value.

2. The method as defined in claim 1 wherein step e) includes calculating the values
K1=(c-peak)−(i-peak-avg)
K2=(c-envelope)−(i-plateau-avg)
K3=(c-envelope)−(i-bias-avg)
and then obtaining a value, m, where
m=K1(c1)+K2(c2)+K3(c3) (abs value of K1,2,3 are used)

3. The method as defined by claim 2 wherein if m is equal to or greater than a specified fraction of the c-envelope, then laser power is adjusted.

4. The method as defined by claim 3 wherein power adjustments are either positive or negative, depending on the sign of K1.

5. The method as defined by claim 4 wherein if K1 is zero, then the sign of K2 is used.

6. The method as defined by claim 5 wherein if K1 and K2 are zero, then the sign of K3 is used.

7. The method as defined by claim 1 wherein steps a), b), and c) are implemented using a write clock wherein the write clock is delayed to accommodate the delay in writing the datum after initiation of a write clock pulse.

8. The method as defined by claim 7 wherein the write clock is further delayed to accommodate a delay from the peak value of the datum to the plateau of the datum.

9. The method as defined by claim 8 wherein step e) includes calculating the values
K1=(c-peak)−(i-peak-avg)
K2=(c-envelope)−(i-plateau-avg)
K3=(c-envelope)−(i-bias-avg)
and then obtaining a value, m, where
m=K1(c1)+K2(c2)+K3(c3) (abs value of K1,2,3 are used)

10. The method as defined by claim 9 wherein if m is equal to or greater than a specified fraction of the c-envelope, then laser power is adjusted.

11. The method as defined by claim 10 wherein power adjustments are either positive or negative, depending on the sign of K1.

12. The method as defined by claim 11 wherein if K1 is zero, then the sign of K2 is used.

13. The method as defined by claim 12 wherein if K1 and K2 are zero, then the sign of K3 is used.

14. Apparatus for measuring parameters of a laser written datum for use in controlling laser power, the datum including a first written pulse and at least a second written pulse, said apparatus comprising:
a) a first pulse detector for measuring a peak value of the first written pulse,
b) a second pulse detector for measuring a plateau value during the second written pulse,
c) a window generator under computer control for applying sampling windows to the first pulse detector and the second pulse detector, and
d) sample and hold circuitry for accessing the first pulse detector and the second detector and providing averages of peak power measurement (i-peak avg) and plateau power measurement (i-plateau avg).

15. Apparatus as defined by claim 14 and further including sample and hold circuitry for accessing the written datum and providing a measure of the datum power envelope (c-envelope).

16. Apparatus as defined by claim 15 wherein the peak power measurement, the plateau power measurement, the datum power envelope, and a programmed power peak value (c-peak) are used to adjust the programmed power peak value.

17. Apparatus as defined by claim 16 wherein programmed power peak value is adjusted by calculating the values
K1=(c-peak)−(i-peak-avg)
K2=(c-envelope)−(i-plateau-avg)
K3=(c-envelope)−(i-bias-avg)
and then obtaining a value, m, where
m=K1(c1)+K2(c2)+K3(c3) (abs value of K1,2,3 are used)

18. Apparatus as defined by claim 17 wherein if m is equal to or greater than a specified fraction of the c-envelope, then laser power is adjusted.

19. Apparatus as defined by claim 18 wherein power adjustments are either positive or negative, depending on the sign of K1.

20. Apparatus as defined by claim 19 wherein if K1 is zero, then the sign of K2 is used.

21. Apparatus as defined by claim 20 wherein if K1 and K2 are zero, then the sign of K3 is used.
